(19) United States
(12) Patent Application Publication
(10) Pub. No.: US 2005/0156960 A1
(43) Pub. Date: Jul. 21, 2005

(54) Printmode selection systems and methods

(76) Inventors: Kenneth J. Courian, San Diego, CA (US); James Kelley, Allen, TX (US); Steven W. Steinfield, San Diego, CA (US); James A. Mott, San Diego, CA (US); Andre Garcia, Poway, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/760,031

(22) Filed: Jan. 16, 2004

(51) Int. Cl. B41J 29/38

(52) U.S. Cl. 347/5; 347/6

(57) ABSTRACT

Printmode selection systems and methods are described. In one embodiment, a method comprises receiving user input that pertains to selection of a printmode that is not a pre-defined printmode for a particular printer; and providing the user with feedback that pertains to a selected printmode.

### TECHNICAL FIELD

The invention pertains generally to printers and methods of operating printers.

### BACKGROUND

Printers, such as laser and inkjet printers, typically come equipped or preconfigured with a set of printmodes. These printmodes are generally defined by the manufacturer. As such, printer users are generally limited, in many circumstances, to using only the printmodes defined by the manufacturer. Needless to say, this results in an inflexible situation.

### BRIEF DESCRIPTION OF THE DRAWINGS

The same numbers are used throughout the drawings to reference like features and components.

FIG. 1 is a high level block diagram of a printer that can be utilized to implement one or more embodiments.

FIG. 2 is a block diagram of a host computer that can be utilized to implement one or more embodiments.

FIG. 3 is a block diagram of an exemplary user interface component in accordance with one embodiment.

FIG. 4 is a high level block diagram of a host computer that embodies the FIG. 3 user interface component, in accordance with one embodiment.

FIG. 5 is a high level block diagram of a printer that embodies the FIG. 3 user interface component, in accordance with one embodiment.

FIG. 6 is a diagram of an exemplary user interface in accordance with one embodiment.

FIG. 7 is a flow diagram that describes steps in a method in accordance with one embodiment.

FIG. 8 is a block diagram of an exemplary user interface in accordance with one embodiment.

FIG. 9 is an illustration of an exemplary user query generated by the user interface of FIG. 8, in accordance with one embodiment.

FIG. 10 is an illustration of an exemplary user query generated by the user interface of FIG. 8, in accordance with one embodiment.

FIG. 11 is a block diagram of an exemplary user interface in accordance with one embodiment.

### DETAILED DESCRIPTION

Overview

Various embodiments provide printer users, and in particular printer end users and operators, with flexibility insofar as being able to define their own printmodes for a particular printer. In some embodiments, the user or operator is provided with a user interface that allows them to define a printmode and then receive feedback which pertains to the printmode that they have defined. In some embodiments, the feedback that the user receives pertains to the consequences of the particular printmode that they have defined. Such will become clearer as the description below is read.

Preliminarily, while the example that is used throughout this document pertains to an inkjet printer, it is to be appreciated and understood that the various embodiments described herein can be employed in the context of any other type of printer (e.g., a laser printer)

Printmodes in General

A printmode typically impacts the manner in which a material such as ink or toner is applied to a print media such as paper. Various parameters can contribute to what is generally known as a printmode. In the inkjet printer context, these parameters can include such things as, without limitation, scan speed, nozzle selection (also referred to as “mask selection”), and the number of passes. Other parameters can also contribute to what is generally known as a printmode. These parameters can include, without limitation, drops per pixel and error hiding (which refers to the substitution of working nozzles for nozzles that have become defective).

In some printers, printmodes can be defined for the user by such terms as “normal”, “draft”, and “best”. By selecting one of these modes, certain parameters are adjusted within the printer to produce a document in accordance with the user's selection. One way of thinking about printmodes is to consider a particular printmode as a tradeoff between print quality and throughput.

For example, selection of the “best” printmode will typically produce a document that is of a generally high quality, albeit at a slower throughput than a lesser quality document printed in “draft” mode.

Exemplary Printing Device Embodiment

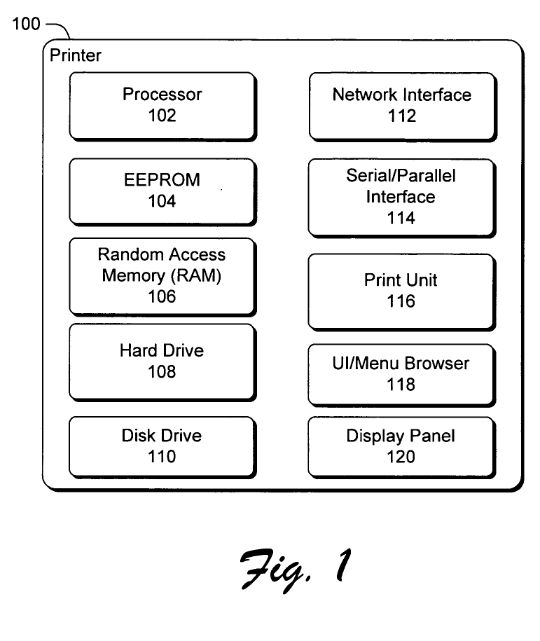

FIG. 1 is a block diagram showing exemplary components of a printing device in the form of a printer 100 that can be used in accordance with one or more of the embodiments described below.

While FIG. 1 illustrates a specific type of printing device, it should be appreciated that other printing devices can be utilized without departing from the spirit and scope of the claimed subject matter. In addition, the term “printer” or “printing device” as used in this document will be understood to include multi-function devices that, in addition to printing, perform additional functions. Such additional functions can include, without limitation, one or more of the following: faxing, copying, scanning and the like. In some embodiments, the printing device can comprise one that is used in the commercial context—such as a so-called large format printer. Large format printers are typically printers that are somewhat larger than typical desktop printers and which can be configured to print upon roll feed media.

Printer 100 includes a processor 102 and at least one computer-readable media. In this example, the computer readable media can include an electrically erasable programmable read-only memory (EEPROM) 104 and a random access memory (RAM) 106. Further, the computer-readable media can include a hard drive 108. Processor 102 processes various instructions to operate the printer 100 and communicate with other devices. Processor 102 can include a printer controller or formatter. Part of the job of a printer controller or formatter is to take data associated with a user's print job, and process it to provide data that is used to operate the printer. For example, in an inkjet printer, a controller can take data associated with a print job and convert it into raster data that can be used to fire pens of a print cartridge. In a laser printer, a formatter can take data associated with a print job and convert it into raster data that is then used to modulate a laser during printing of the print job.

The EEPROM 104, RAM 106, and/or hard drive 108 can store various information such as configuration information, fonts, templates, data being printed, and menu structure information.

In addition, although not shown in FIG. 1, a particular printer may also contain a ROM (non-erasable) in place of or in addition to EEPROM 104. Furthermore, a printer may alternatively contain a flash memory device in place of or in addition to EEPROM 104.

Printer 100 can also include a disk drive 110, a network interface 112, and a serial/parallel interface 114. Disk drive 110 provides additional storage for data being printed or other information used by the printer 100. Although both RAM 106 and disk drive 110 are illustrated in FIG. 1, a particular printer may contain either RAM 106 or disk drive 110, depending on the storage needs of the printer. For example, an inexpensive printer may contain a small amount of RAM 106 and no disk drive 110, thereby reducing the manufacturing cost of the printer. Network interface 112 provides a connection between printer 100 and a data communication network. Network interface 112 allows devices coupled to a common data communication network to send print jobs, menu data, and other information to printer 100 via the network. The network interface can be embodied as a network server and, more particularly, as a Web server. As a network server or Web server, the network interface can enable a user to access the printer using standard network protocols. For example, as a Web server, the network interface can enable two-way communication with one or more clients via standard network protocols such as TCP/IP.

Serial/parallel interface 114 can also provide a data communication path directly between printer 100 and another device, such as a workstation, server, or other computing device. Although the printer 100 shown in FIG. 1 has two interfaces (network interface 112 and serial/parallel interface 114), a particular printer may only contain one interface.

Printer 100 also includes a print unit 116 that can comprise a print engine. As such, the print unit 116 can comprise mechanisms that are arranged to selectively apply fluid or ink (e.g., liquid ink, dry toner, liquid toner, etc.) to a print media (e.g., paper, plastic, fabric, etc.) in accordance with print data within a print job.

Thus, for example, print unit 116 can include a conventional laser printing mechanism or print engine that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

The print unit 116 can also comprise an ink jet print unit or print engine that utilizes principles of ink jet printing. Those skilled in the art will recognize that there are many different types of print units or print engines available, and that for the purposes of the present discussion, print unit 116 can include any of these various types.

Printer 100 can also contain a user interface/menu browser 118 and a display panel 120. User interface/menu browser 118 allows the user of the printer to navigate the printer's menu structure. User interface 118 may be a series of buttons, switches or other indicators that are manipulated by the user of the printer. Display panel 120 is a graphical display that provides information regarding the status of the printer and the current options available through the menu structure.

In various embodiments described below, the user interface 118 and display panel 120 can be configured to enable the user to make selections with respect to selecting a printmode and receive feedback which pertains to the printmode that they have selected. Such will become more apparent below.

The illustrated printer can, and typically does include software that provides a runtime environment in which software applications or applets can run or execute. The runtime environment can facilitate the extensibility of the printer by allowing various interfaces to be defined that, in turn, allow applications or applets to interact with the printer in more robust manners.

It will be appreciated that the techniques and methods described herein can include all forms of computer-readable media when such media contains instructions which, when executed by a processor or computer, implement the techniques and methods.

Host Computer

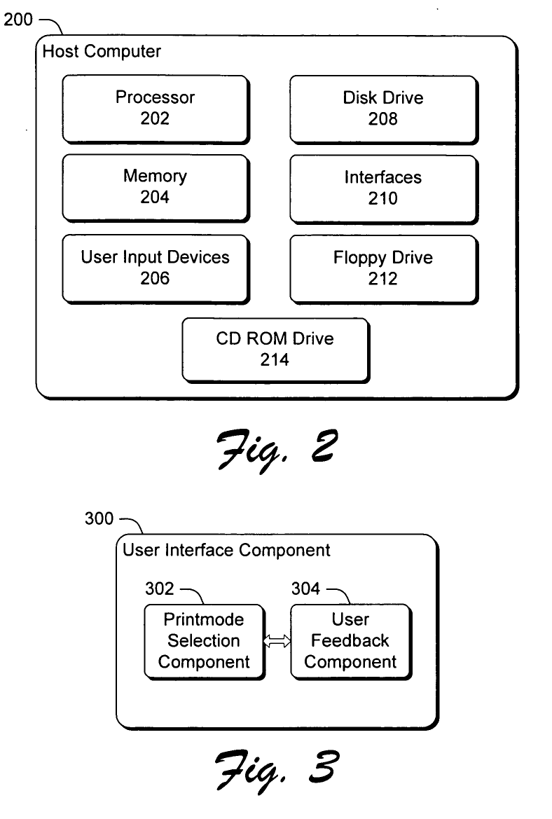

FIG. 2 is a block diagram showing exemplary components of an exemplary host computer 200 that can be utilized in connection with the printer of FIG. 1. Computer 200 includes a processor 202, a memory 204 (such as ROM and RAM), user input devices 206, a disk drive 208, interfaces 210 for inputting and outputting data, a floppy disk drive 212, and a CD-ROM drive 214.

Processor 202 can perform various instructions, under the influence of software such as an operating system and various applications, to control the operation of computer 200. Memory 204, disk drive 208, and floppy disk drive 212, CD-ROM drive 214 and a hard drive 216 can provide data storage mechanisms. User input devices 206 include a keyboard, mouse, pointing device, or other mechanism for inputting information to computer 200. Interfaces 210 provide a mechanism for computer 200 to communicate with other devices.

In at least one embodiment, the host computer includes software that enables the user to define their own printmodes and receive feedback which pertains to the printmode that they have defined, in much the same way as mentioned above in connection with the printer of FIG. 1.

Exemplary Embodiment

FIG. 3 illustrates an exemplary user interface component 300 in accordance with one embodiment. The user interface can be implemented in any suitable hardware, software, firmware or combination thereof. In one embodiment, user interface component 300 comprises a printmode selection component 302 and a user feedback component 304.

In one embodiment, printmode selection component 302 is configured to allow the user to make a printing selection that can affect a printer's print quality and throughput. In at least some embodiments, the selection of the printmode that is made by the user via the printmode selection component selects a printmode that has not been pre-defined for the particular printer by the printer's manufacturer or some other entity. Thus, in this embodiment, the user can effectively define his or her custom printmode. In a typical scenario, when the user selects a particular printmode using the printmode selection component 302, the printer adjusts individual parameters that are associated with the printmode selected by the user. These parameters can include such things as scan speed, print mask (i.e. the combination of nozzles that is to be used to print the user's job), nozzle firing frequency, resolution, drops per pixel, and the like.

In some embodiments, the printmode selection component 302 can be implemented as a hard control that the user physically engages, such as a knob or switch. Alternately or additionally, the printmode selection component 302 can be implemented as a soft control, such as a graphical user interface (GUI) such as a slider or engagable knob.

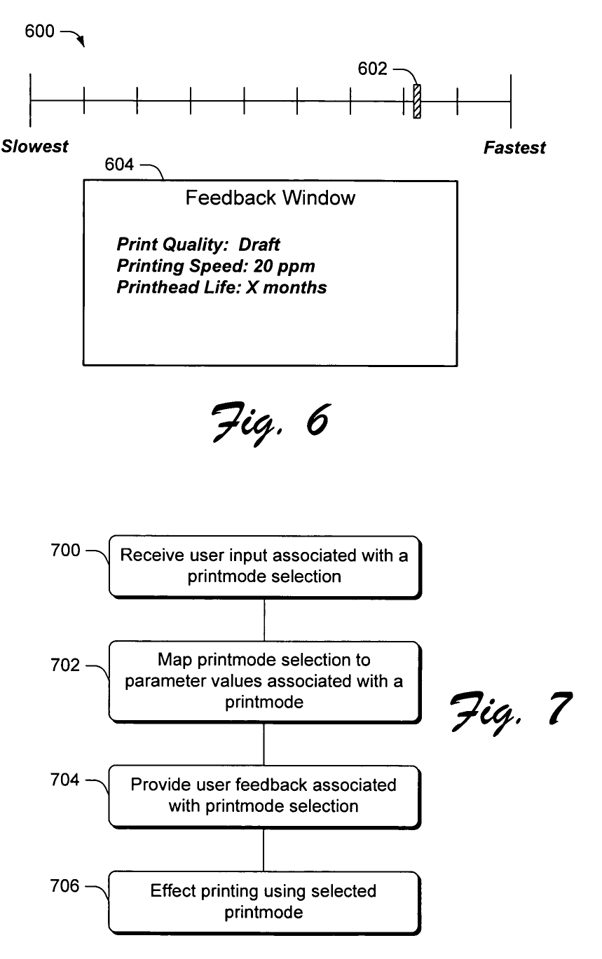

In one embodiment, the user feedback component 304 provides feedback to the user that pertains to the particular printmode that they have selected. This feedback can include such things as specific parameters values associated with the selected printmode, estimated printing time as a function of the selected printmode, and the like. One specific example of a user interface is provided below in FIG. 6.

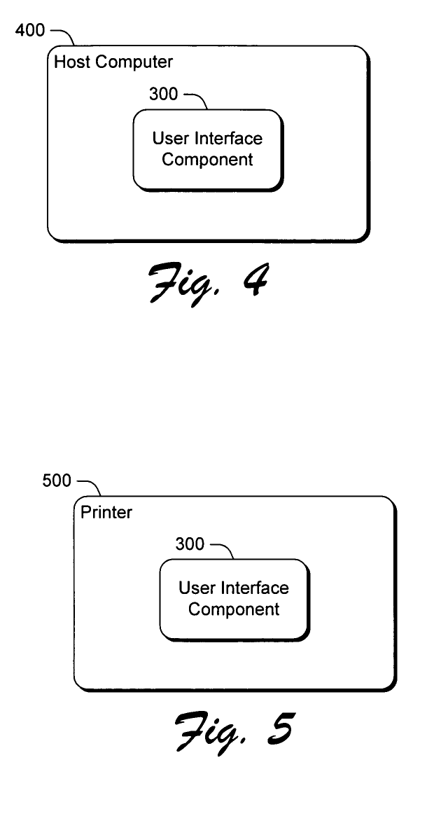

The user interface component 300 can be embodied at any suitable location in a system that includes a printer and/or a host computer such as those described above. For example, the user interface component 300 can be embodied and reside on a host computer system, such as that shown in FIG. 4 at 400. In this embodiment, the user interface component 300 can, but need not necessarily comprise part of a printer's driver software. In this example, the user interface component 300 can be embodied as a soft control in the form of a GUI.

Alternately or additionally, the user interface component 300 can be embodied and reside on the printer, such as that shown in FIG. 5 at 500. In this embodiment, the user interface can be embodied as a hard control or a soft control. In the described embodiments, a hard control is a physical control, such as a knob or switch, that is physically engagable by a user. A soft control is a control that is typically rendered by software and is manipulated by a user input device such as a mouse, keyboard or touchscreen.

Exemplary User Interface

FIG. 6 shows an exemplary user interface in accordance with one embodiment generally at 600. In this particular example, user interface 600 comprises a means 602 for enabling a user to make a selection along a continuum of printing speeds. In this particular example, the selection means 602 comprises a slider switch that the user can position between a slowest printing speed (corresponding to the highest quality mode) and a fastest printing speed (corresponding to a draft-like mode). In addition, in this example, a feedback providing means 604 provides feedback to the user that pertains to their printing speed selection. In this example, the feedback providing means is embodied as a window (either a soft or a hard window) within which information is displayed for the user. For example, information pertaining to the print quality associated with the user's speed selection (i.e. draft), the printing speed (20 pages per minute), and the printhead life (“X months”) is displayed for the user so that they can view and appreciate the consequences of their decision.

In this specific example, the user can be given a continuum of potentially hundreds of different printmodes to select from. So, for example, in a situation where a user is printing on a piece of media that has not been qualified by the printer's manufacturer, the user may, through trial and error, experiment to find the best slider selection for that particular piece of media. The user can then cause the best slider selection to be saved as a user-defined printmode for a particular associated type of media. In this example, the user can flexibly select a printmode that is most satisfactory to them, without being constrained to only those printmodes that have been pre-selected by the manufacturer or some other entity.

In this example, software that executes as part of the user interface component can process the user's input to interpolate or otherwise calculate parameter values for the user-selected printmode. For example, along the continuum of FIG. 6, at various known locations, pre-defined printmodes with known parameter values exist. When a user selects a slider position between two known printmode settings, software executing on either the printer or the host computer can algorithmically interpret or map the user's input to arrive at a set of parameter values that coincide to the user's selection. For example, the software may linearly interpolate parameter values for parameters such as scan speed, firing frequency, dots per inch and the like.

As an example, consider the following inkjet scenario. As noted above, a so-called error hiding parameter can contribute to what is considered a printmode. Specifically, error hiding refers to the substitution of working nozzles for nozzles that have become defective. When a user decides to select a higher throughput as by increasing the printing speed as in the FIG. 6 example, or opts to increase the print density to apply more ink to a given pixel location, the associated software can calculate the level of redundancy that is available based on the firing frequency for the system. Typically, a certain throughput is available for a certain level of print quality as the total number of nozzles is parceled out to tasks based on the redundancy of the system. As the availability of redundant nozzles decreases with a higher throughput demand i.e. firing another nozzle at a given pixel location allows both nozzles to operate at a lower firing frequency while overall throughput can increase, or as the available redundant nozzles decreases because of an increase in ink density, the print quality level will indicate a reduction since some of the nozzles used for errors and missing nozzles will be used up to accommodate for the increased throughput and/or ink density.

Effectively then, one of the things that the software can do in this example is to analyze the user's choices as those choices impact error hiding. If a user chooses, for example, to increase throughput and/or ink density, those choices can affect the ability of the print to error hide. The lessened capacity of the printer to error hide, in turn, can affect the print quality of the ultimately printed product. The software can then return to the user, via a user interface, an expected change in the print quality, pen life and the like. Specifically, the software can balance the demands for throughput and ink density with the set system constraints (e.g. the total number of nozzles in the system, nozzles per inch, nozzle maximum firing frequency, and the like). The software then returns to the user display the expected change in the quality of the output (e.g. toggling to 300 dpi output from 600 dpi). For example, there can typically be a variety of toggle points based on the system's fixed constraints, and the user's input as such affects the throughput and ink density. The software can make tradeoffs until the system hard stops are reached.

FIG. 7 is a flow diagram that describes steps in a method in accordance with one embodiment. The method can be implemented utilizing any suitable hardware, software, firmware or combination thereof. In one embodiment, the method can be implemented by software executing on one or more of a printer or a host computer connected to a printer.

Step 700 receives user input associated with a printmode selection. This step can be implemented in a number of different ways. For example, a printer can be provided with a hard user interface (such as a knob or switch) or a soft user interface through which a user can enter their selection. In the example of FIG. 6, the user interface comprises a soft slider that is engagable to select along a continuum. Alternately or additionally, a host computer can be provided with a soft interface through which a user can provide their input. Step 702 maps a printmode selection to parameter values associated with the printmode. For example, if a user happens to select a printmode that is preconfigured on the printer, then the printer can default to parameters values associated with the preconfigured printmode. On the other hand, if a user happens to make a selection that does not coincide with a preconfigured printmode, then software can map the user's input to suitable parameter values for use in printing the user's job. Mapping can take place using any suitable techniques or approach. One approach is to linearly interpolate between known printmode parameter values. Other approaches, however, can be used without departing from the spirit and scope of the claimed subject matter.

Step 704 provides the user with feedback associated with their printmode selection. Any suitable feedback can be provided, with examples being given above and below. Step 706 then effects printing using the selected printmode.

Implementation Example Using a Large Format Printer

In the example that follows, an implementation of various concepts discussed above, as well as other concepts, is provided in the context of a so-called large-format printer. Large format printers are typically used in commercial settings, as will be appreciated by the skilled artisan. It is to be appreciated and understood that the concepts described in this example are not to be solely limited to large format printers. Rather, the various concepts can be applied in contexts other than large format contexts.

In the large format printing context, print service providers serve a diverse customer base, including artists, businesses, and the general public. It is desirable to have a large format printer be fairly flexible to allow the print service provider to maximize their business across a multitude of applications and media. Printer manufacturers generally have little control over the type of prints made on their machines or the type of media that is used. The embodiment about to be described incorporates an intuitive method/system for controlling a larger selection of printmodes, and provides feedback to the user about those printmodes.

FIG. 8 shows an exemplary user interface in accordance with one embodiment generally at 800. In this particular example, the user interface comprises part of the front panel of a printer. The user interface enables a user to select from a large number of printmodes and be provided with feedback that pertains to their choices, as will become apparent below.

In accordance with the illustrated and described embodiment, user interface 800 comprises an ink density control 802, a throughput control 804, an alternate printmode control 806, a color/mono control 808 and a feedback window 810, each of which is discussed under its own heading below. A change in any of the illustrated controls can cause the printer to switch to a different printmode, and information about each printmode can be provided to the user via the feedback window 810.

Ink Density Control

The ink density control 802 allows the user to control the amount of ink that is placed on the media by switching between families of printmodes that each apply a different number of ink drops per pixel. For example, a printmode that outputs 100% ink density can allow no more than 1 drop of ink per pixel. Printing with a 200% density printmode allows a maximum of 2 drops per pixel from any combination of printheads. Many existing printmodes print 200% density because true secondary colors can be generated at a single pixel location by mixing drops of two different primary colors. For instance, cyan and magenta ink drops fired at the same pixel location mix at the media surface to make blue. An 800% density printmode, at 8 ink drops per pixel, allows a user to print on very absorbent media, such as canvas, to achieve sufficient ink coverage. A printmode can multi-dot a pixel with the same color ink through several different techniques. Two techniques use multiple carriage passes. The first technique works by printing on the same pixels during multiple carriage passes without advancing the paper. The second technique multi-dots a pixel by firing an alternate nozzle during a different carriage pass. Other multi-dot methods include firing nozzles at extremely high frequency so that each nozzle puts multiple ink drops on a single pixel within the same carriage pass.

An additional feature of ink density control 802, in this embodiment, is a default setting. The default setting selects a subset of particular printmodes qualified by Hewlett-Packard for HP Media. In FIG. 8, “000 Default Density (HP Media)” has been selected with the ink density control. Feedback window 810 then displays the type of HP Media loaded in the printer. In this example, HP Heavy Coated Media is loaded. Additionally, as indicated in the feedback window 810, for this particular type of media, the default print density is 200% in a 12-pass bi-directional printing process. Additionally, the feedback window provides the user with feedback as to the estimated printing times associated with different sized plots, e.g. 6 minutes for A-sized plots, 12 minutes for B-sized plots and so on.

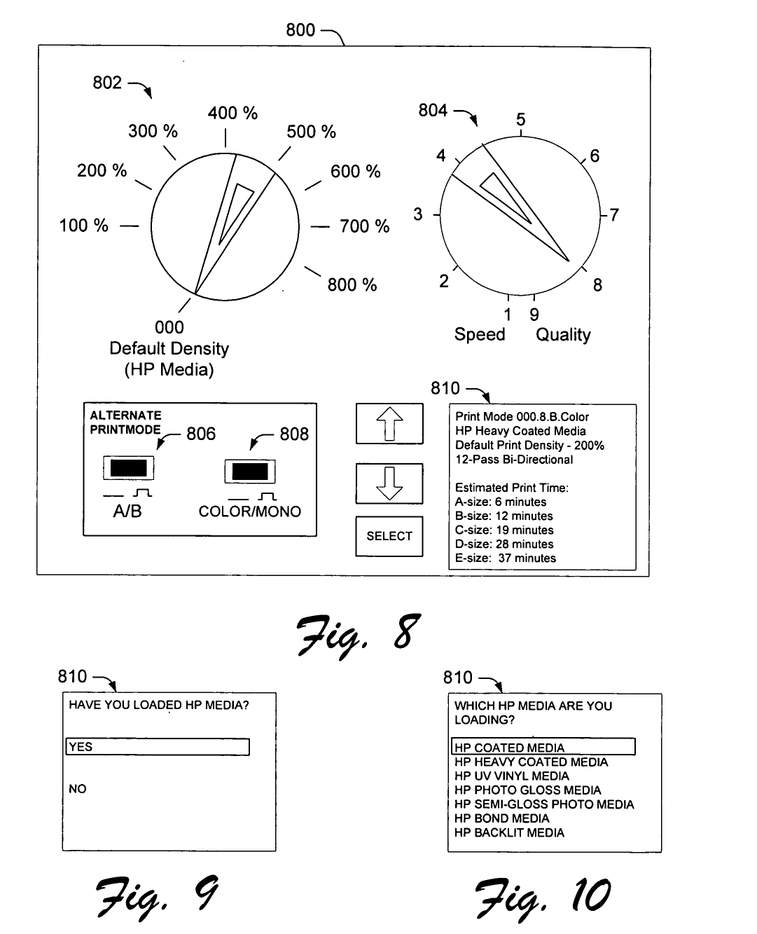

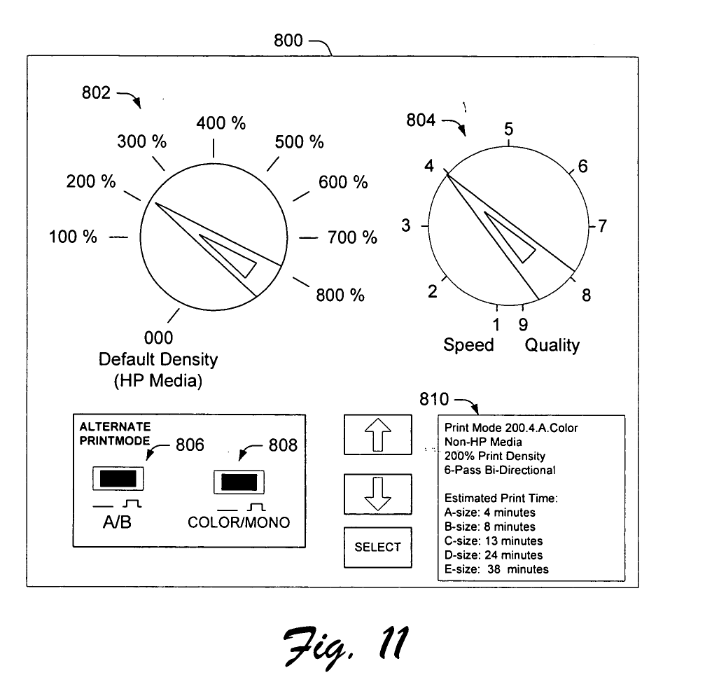

The qualified printmodes effectively limit the user to the default print densities that work desirably for the particular HP media type loaded in the printer. When the user loads a new roll of media into the printer, the feedback window 810 can interactively query the user to make sure that the front panel printmode settings are appropriate, particularly if an HP Media is loaded. As an example, consider FIGS. 9 and 10. In FIG. 9, the feedback window 810 displays a user query which asks the user if they have loaded HP media. The user can respond by using the arrow and select buttons. In FIG. 10, the feedback window asks the user to select the type of HP media that they have loaded. Again, the user can respond by using the arrow and select buttons.

Throughput Control

The throughput control 804 can intuitively display the print speed and quality trade-off for each printmode. In this example, around the circumference of the illustrated control are various notches or designations that denote unique printmodes—i.e. “1” through “8”. If the specific application (i.e., HP Media) is selected on the ink density control, then the printmode selection around the throughput control defaults to those tested and qualified by Hewlett-Packard for the type of HP media loaded in the printer. Note that the printmodes qualified for HP media likely constitute a subset of the entire printmode portfolio, and therefore will be duplicated at consecutive throughput control selections (e.g. settings 1, 2, & 3 might all be the same fast printmode).

In this particular example, setting 1 constitutes a highest speed-lowest quality setting. Conversely, setting 9 constitutes a lowest speed-highest quality setting. Those settings in between settings 1 and 9 constitute settings that decrease in speed and increase in quality as one moves from 1 towards 9. Other conventions are, of course, possible.

Alternate Printmode Control

The alternate printmode control 806 enables a user to select between two or more print masks for a given printmode. As noted above, a print mask typically determines the pattern or order that pixels get printed as the printhead moves along the media during multi-pass printing. Every printhead has a unique pattern of nozzle trajectory errors, and when this pattern interacts with a particular print mask, the interaction can sometimes make image quality worse than if another print mask was used. For a given printmode, the ink density and throughput are generally not affected by a change in the print mask. The alternate printmode control allows the user to change the print mask for an application if the initial printing results are dissatisfying. The example in the figure gives only two choices (A or B), but it is to be appreciated and understood that the alternate printmode control can be configured to select from more than two print masks. Note that with each additional print mask selection, the entire printmode portfolio will double in size.

Color/Mono Control

The color/mono control 808 can enable a user to select between printmodes using 4 printheads (e.g. KCMY), or a single printhead (K only) for monochrome printing. As will be appreciated by the skilled artisan, black and white printing can be accomplished by using either composite KCMY colors or by using black alone.

Feedback Window

The feedback window 810 can be utilized to provide a variety of feedback information to the user. As an example, consider the following. In this particular example, the feedback window provides the following information about a selected printmode: the printmode name, the number of passes, the direction of printing (i.e., unidirectional or bi-directional), the maximum print density (maximum drops per pixel), and the estimated printing time for various sized media. In some embodiments, a printmode name is the concatenation of all the control feature settings, and is designed to aid the user in remembering a useful or favorite setting. For example, in FIG. 8, the printmode is identified as “000.8.B.Color for HP Heavy Coated Media”. The number 000 identifies that the default ink density for HP Heavy Coated Media will be used (200% density for this media, according to the feedback window). The number 8 reflects the fact that the throughput has been set to “8” on the throughput control 804. The letter “B” means that Alternate Printmode B was selected, and “Color” means that all four printheads (KCMY) are to be used when printing.

FIG. 11 gives a user interface example, this time with some type of non-HP Media loaded in the printer. The printmode name, “200.4.A.Color” implies that the user chose a 200% density printmode with a quality level of 4 (out of 9 in this example) with printmode alternate “A” in full color.

Conclusion

Various embodiments described above can provide printer users, and in particular printer end users and operators, with flexibility insofar as being able to define their own printmodes for a particular printer. In some embodiments, the user or operator is provided with a user interface that allows them to define a printmode and then receive feedback which pertains to the printmode that they have defined. In some embodiments, the feedback that the user receives pertains to the consequences of the particular printmode that they have defined.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
receiving user input associated with a printmode selection;
mapping said printmode selection to one or more parameter values associated with the printmode; and
providing the user with feedback associated with consequences of their printmode selection.

2. The method of claim 1, wherein said act of receiving is performed using a hard user interface.

3. The method of claim 1, wherein said act of receiving is performed using a soft user interface.

4. The method of claim 1, wherein said act of receiving is performed by at least one printer.

5. The method of claim 1, wherein said act of receiving is performed by at least one host computer in operable communication with at least one printer.

6. The method of claim 1, wherein said act of receiving comprises receiving user input associated with ink density.

7. The method of claim 1, wherein said act of receiving comprises receiving user input associated with throughput.

8. The method of claim 1, wherein at least one of the parameter values is associated with error hiding.

9. The method of claim 1, wherein the act of providing is performed by providing the user with feedback on print quality associated with the printmode selection.

10. The method of claim 1, wherein the act of providing is performed by providing the user with feedback on one or more parameter values associated with the printmode selection.

11. The method of claim 10, wherein at least one parameter value comprises a value associated with estimated printing time.

12. The method of claim 10, wherein at least one parameter value comprises a value associated with ink or toner density.

13. The method of claim 1 further comprising effecting printing using the selected printmode.

14. A method comprising:
receiving user input that pertains to selection of a printmode that is not a pre-defined printmode for a particular printer; and
providing the user with feedback that pertains to a selected printmode.

15. The method of claim 14, wherein said act of receiving comprises receiving input pertaining to print quality.

16. The method of claim 14, wherein said act of receiving comprises receiving input pertaining to throughput.

17. The method of claim 14, wherein said act of receiving comprises receiving input pertaining to print quality and throughput.

18. The method of claim 14 further comprising responsive to receiving said user input, adjusting one or more printmode parameters.

19. The method of claim 18, wherein at least one parameter comprises a scan speed parameter.

20. The method of claim 18, wherein at least one parameter comprises a parameter associated with print masks.

21. The method of claim 18, wherein at least one parameter comprises a parameter associated with nozzle firing frequency.

22. The method of claim 18, wherein at least one parameter comprises a parameter associated with drops per pixel.

23. The method of claim 18, wherein at least one parameter comprises a parameter associated with scan direction.

24. The method of claim 18, wherein said parameters comprise parameters selected from a group of parameters associated with scan speed, print masks, nozzle firing frequency, and drops per pixel.

25. The method of claim 18, wherein said act of providing comprises providing the user with feedback that pertains to an expected change in print quality responsive to said user input.

26. The method of claim 14 further comprising saving a printmode selection as a user-defined print mode.

27. One or more computer-readable media having computer-readable instructions thereon which, when executed by one or more processors, cause the one or more processors to execute a method comprising:
receiving user input that pertains to selection of a printmode that is not a pre-defined printmode for a particular printer; and
providing the user with feedback that pertains to the selected printmode.

28. The one or more computer-readable media of claim 27, wherein the act of receiving comprises receiving input pertaining to print quality.

29. The one or more computer-readable media of claim 27, wherein the act of receiving comprises receiving input pertaining to throughput.

30. The one or more computer-readable media of claim 27, wherein the act of receiving comprises receiving input pertaining to print quality and throughput.

31. The one or more computer-readable media of claim 27, wherein the method further comprises responsive to receiving said user input, adjusting one or more printmode parameters.

32. The one or more computer-readable media of claim 31, wherein at least one parameter comprises a scan speed parameter.

33. The one or more computer-readable media of claim 31, wherein at least one parameter comprises a parameter associated with print masks.

34. The one or more computer-readable media of claim 31, wherein at least one parameter comprises a parameter associated with nozzle firing frequency.

35. The one or more computer-readable media of claim 31, wherein at least one parameter comprises a parameter associated with drops per pixel.

36. The one or more computer-readable media of claim 31, wherein said parameters comprise parameters selected from a group of parameters associated with scan speed, print masks, nozzle firing frequency, and drops per pixel.

37. The one or more computer-readable media of claim 27, wherein the method further comprises saving a printmode selection as a user-defined print mode.

38. A user interface component comprising:
a printmode selection component configured to receive user input that pertains to selection of a printmode that is not a pre-defined printmode for a particular printer; and
a user feedback component configured to provide the user with feedback that pertains to a selected printmode.

39. The user interface component of claim 38, wherein said printmode selection component comprises at least one hard control.

40. The user interface component of claim 38, wherein said printmode selection component comprises at least one soft control embodied on a computer-readable medium.

41. The user interface component of claim 38, wherein said printmode selection component is configured to receive input pertaining to print quality.

42. The user interface component of claim 38, wherein said printmode selection component is configured to receive input pertaining to throughput.

43. The user interface component of claim 38, wherein said printmode selection component is configured to receive input pertaining to print quality and throughput.

44. The user interface component of claim 38, wherein said user feedback component is configured to provide feedback that pertains to estimated printing time.

45. The user interface component of claim 38, wherein said user feedback component is configured to provide feedback that pertains to print quality.

46. The user interface component of claim 38, wherein said user feedback component is configured to provide feedback that pertains to printhead life.

47. The user interface component of claim 38, embodied on at least one host computer that is connected to an associated printer.

48. The user interface component of claim 38, embodied on at least one printer.

49. The user interface component of claim 38, wherein said printmode selection component is configured to enable a user to make a selection along a continuum of printing speeds.

50. An apparatus comprising:
means for receiving user input that pertains to selection of a printmode that is not a pre-defined printmode for a particular printer; and
means for providing the user with feedback that pertains to a selected printmode.

51. The apparatus of claim 50, wherein said means for receiving comprises at least one hard control.

52. The apparatus of claim 50, wherein said means for receiving comprises at least one soft control.

53. The apparatus of claim 50, wherein said means for providing a user with feedback comprises a window.

54. The apparatus of claim 50, wherein said means for providing a user with feedback comprises a soft window.

55. The apparatus of claim 50, wherein said means for providing a user with feedback comprises a hard window.

56. The apparatus of claim 50, wherein said means for providing a user with feedback comprises a window, and said feedback comprises information that pertains to print quality.

57. The apparatus of claim 50, wherein said means for providing a user with feedback comprises a window, and said feedback comprises information that pertains to printing speed.

58. The apparatus of claim 50, wherein said means for providing a user with feedback comprises a window, and said feedback comprises information that pertains to printhead life.

59. The apparatus of claim 50, wherein said means for providing a user with feedback comprises a window, and said feedback comprises information that pertains to a number of printing passes.

60. A printer embodying the apparatus of claim 50.

61. A host computer embodying the apparatus of claim 50.

62. A user interface component comprising:
an ink density control configured to allow a user to select an amount of ink that is to be placed on a print media; and
a feedback window configured to provide a user with feedback associated an ink density selection made by the user.

63. The user interface component of claim 62, wherein said feedback comprises a printmode name.

64. The user interface component of claim 62, wherein said feedback comprises a number of passes to be made.

65. The user interface component of claim 62, wherein said feedback comprises a printing direction.

66. The user interface component of claim 62, wherein said feedback comprises estimated printing time.

67. A printer embodying the user interface component of claim 62.

68. The user interface component of claim 62 further comprising an alternate printmode control configured to enable a user to select between multiple print masks for a given printmode.

69. The user interface component of claim 62 further comprising a color/mono control configured to enable a user to select printheads that are used for printing.

70. A user interface component comprising:
a throughput control configured to enable a user to make a selection between print speed and quality;
a feedback window configured to provide a user with feedback associated with a throughput selection made by the user.

71. The user interface component of claim 70, wherein said feedback comprises a printmode name.

72. The user interface component of claim 70, wherein said feedback comprises a number of passes to be made.

73. The user interface component of claim 70, wherein said feedback comprises a printing direction.

74. The user interface component of claim 70, wherein said feedback comprises estimated printing time.

75. A printer embodying the user interface component of claim 70.

76. The user interface component of claim 70 further comprising an alternate printmode control configured to enable a user to select between multiple print masks for a given printmode.

77. The user interface component of claim 70 further comprising a color/mono control configured to enable a user to select printheads that are used for printing.

78. A user interface component comprising:
an ink density control configured to allow a user to select an amount of ink that is to be placed on a print media;
a throughput control configured to enable the user to make a selection between print speed and quality;
an alternate printmode control configured to enable the user to select between multiple print masks for a given printmode;
a color/mono control configured to enable the user to select printheads that are used for printing; and
a feedback window configured to provide a user with feedback associated with selections made by the user.

79. The user interface component of claim 78, wherein said feedback comprises a printmode name.

80. The user interface component of claim 78, wherein said feedback comprises a number of passes to be made.

81. The user interface component of claim 78, wherein said feedback comprises a printing direction.

82. The user interface component of claim 78, wherein said feedback comprises estimated printing time.

83. A printer embodying the user interface component of claim 78.
